(19) United States
(12) Patent Application Publication
(10) Pub. No.: US 2008/0066316 A1
(43) Pub. Date: Mar. 20, 2008

(54) Corn stripper

(76) Inventor: Tommy Lee Schwab, Central City, IA (US)

Correspondence Address: DAVIS, BROWN, KOEHN, SHORS & ROBERTS, P.C.;THE FINANCIAL CENTER, 666 WALNUT STREET, SUITE 2500, DES MOINES, IA, 50309-3993, US

(21) Appl. No.: 11/521,873

(22) Filed: Sep. 15, 2006

(51) Int. Cl. A47J 17/02

(52) U.S. Cl. 30/121.5

(57) ABSTRACT

The present invention teaches a corn stripper for removing kernels from ear corn. The corn stripper has a relatively tall annular stripper element of a fixed diameter. A bow tie shaped handle is secured to the stripper element at its narrow central section to provide a pair of wide hand graspable sections for manipulation of the corn stripper. The leading or lower edge of the stripper element is not sharpened, but is rounded or chamfered to limit cutting or rending of the kernels during removal. The handle preferably flares upwardly away from the stripper element to keep the handle and hands of the user above the work surface and any accumulated kernels.

### BACKGROUND OF THE INVENTION

The invention relates generally to a hand-operated corn stripper and, more specifically, to a rigid, unitary tool for removing kernels of corn from an ear of fresh or cooked corn.

Corn is a popular vegetable. Most often, the corn consumed by humans is what is referred to as “sweet corn” as opposed to “field corn.” Sweet corn may be eaten “on the cob” where the corn is usually cooked and then eaten by hand from the cob where the consumer removes the kernels from the cob with the teeth. Alternatively, the corn kernels may be removed from the cob prior to being eaten, either from fresh, uncooked ears of corn or from ears of corn that have already been cooked. A large quantity of sweet corn is preserved by households every year, a process that requires that the kernels be removed from the cob prior to canning or freezing.

A great many tools for removing the kernels from the cob are known. U.S. Pat. No. 2,511,933 describes a hand corn cutter having a single, open handle and a cutting element made from a pair of annular sections the diameter of which is adjustable to accommodate ears of corn of various sizes. U.S. Pat. No. 2,447,301 teaches a tool for removing the kernels from cooked sweet corn having a sharpened, two-piece annular cutter attached to the end of a handle. U.S. Pat. No. 1,224,474 discloses a green corn cutting and scraping implement which has a pair of resilient handle members on opposite sides of an annular cutting and scraping member the diameter of which is controlled by manipulation of the resilient handle members. U.S. Pat. No. 3,077,909 describes a corn cutter that has a split, tall, frustoconically shaped cutter element and a pair of opposing hand grips that are used to manipulate the cutter and allow the diameter of the cutter element to adjust and closely follow the cob. U.S. Pat. No. 2,823,716 teaches a sweet corn cutter having a frustoconical cutter attached at the end of a handle with the cutter having a beveled, sharpened cutting edge. U.S. Pat. No. 4,402,137 discloses a corn ear stripper having an annular cutting element that is open to allow adjustment of the diameter of the cutting element by manipulation of the two independent handles attached on either side of the cutting element.

The known tools suffer from a variety of drawbacks. The open or adjustable annular cutting member makes the tool too flexible for reliable handling and is not usually helpful in efficiently removing the kernels from the cob. Tools with single handles are difficult to hold in alignment with the longitudinal axis of the cob and so drift and either leave kernels or parts of kernels or remove portions of the undesirable cob. There is a need, therefore, for a simple, efficient, and easy to use tool for stripping the kernels off of fresh or cooked ears of corn, and particularly sweet corn.

### SUMMARY OF THE INVENTION

### Brief Description of the Drawings

FIG. 1 is a perspective view of a preferred embodiment of a corn stripper of the present invention in use stripping the kernels from an ear of corn.

FIG. 2 is a side elevational view of a corn stripper corresponding to FIG. 1.

FIG. 3 is an end elevational view of a corn stripper corresponding to FIG. 1.

FIG. 4 is a plan view of a corn stripper corresponding to FIG. 1.

### DETAILED DESCRIPTION OF PREFERRED EMBODIMENTS

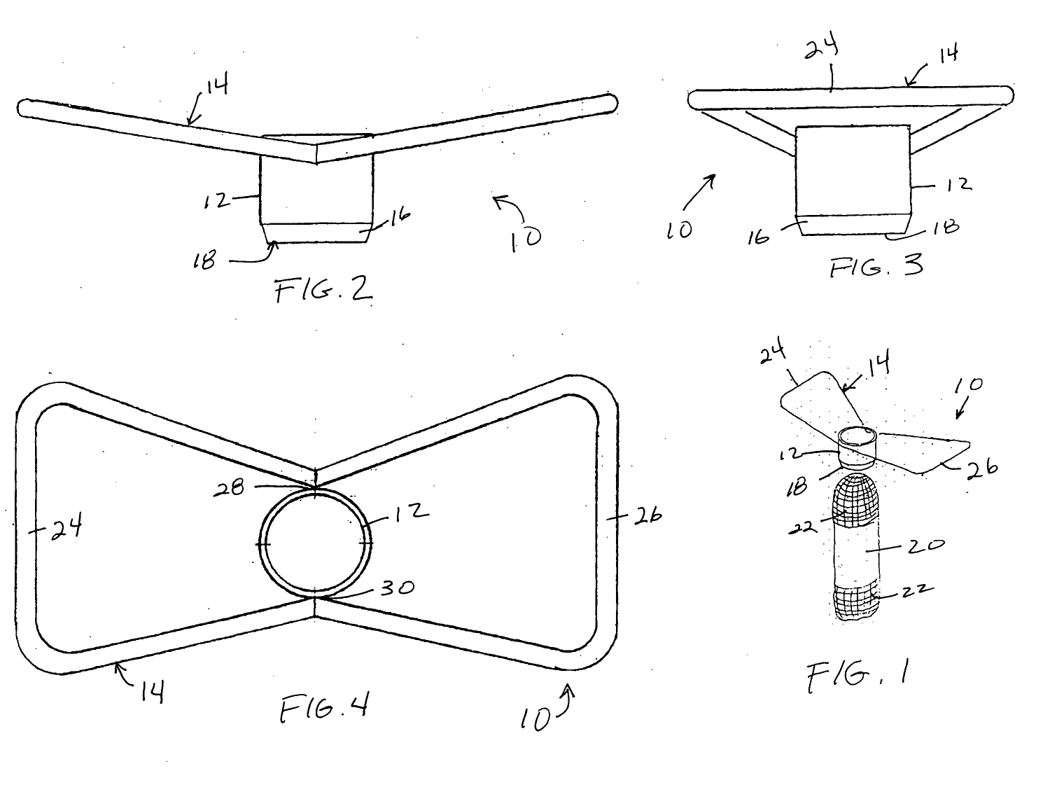

Illustrated in FIGS. 1-4, generally at 10, is a preferred embodiment of the corn stripper of the present invention. The corn stripper 10 includes an annular barrel or stripper element 12 secured centrally to a handle 14. The stripper element 12 preferably has a beveled lower edge portion 16 that terminates in a circular chamfered or rounded edge 18. In use, the corn stripper 10 is positioned above an ear of corn 20 with the central axis of the stripper element 12 generally aligned with the longitudinal axis of the ear of corn 20. The stripper element 12 is then moved downwardly along the cob of the ear of corn 20 by hand pressure on the handle 14. Kernels 22 are stripped from the ear of corn 20 by the stripper element 12, initially by the chamfered edge 18. It is sometimes preferably to have a prong (not shown) or other means for holding the ear 20 upright during the stripping operation.

The stripper element 12 is preferably of a length or height that assists in maintaining the general alignment of the stripper element 12 and the ear of corn 20. If the stripper element 12 is short, there will be insufficient contact of engagement between the stripper element 12 and the cob of the ear of corn 20 to act to prevent tipping of the corn stripper 10 relative to the ear of corn 20. This will make it more difficult for a user to maintain the general alignment and assure complete and even removal of the kernels without removing any of the undesired cob. It has been found that a length or height of the stripper element 12 of between one-half and two times the diameter of the stripper element 12, and preferably between about three-fourths and about five-fourths of the diameter, will assist in maintaining general alignment without being unnecessarily long or tall.

The handle 14 is of a generally bow tie shape, having a pair of opposed grasping sections 24 and 26 which are hand grasped by a user. The handle 14 tapers toward the center where it is secured at two places, 28 and 30, on opposite sides of the stripper element 12. Note that the handle 14 is of a generally V-shape when viewed from the side (FIG. 2) such that the grasping sections 24 and 26 are higher than the chamfered edge 18. The V-shape assists in keeping the handle 14 and hands of a user above the surface supporting the ear of corn 20 so that full working motion of the corn stripper 10 can be achieved and also likely above and clear from contact with any stripped kernels that may accumulate in the work area.

The edge 18 of the stripper element 12 is preferably rounded or chamfered rather than being sharpened. It has been found, surprisingly, that a rounded or chamfered edge 18 is more likely to remove a kernel 22 in its whole condition whereas a sharpened edge cuts the kernels 22 making it more likely that portions of the kernels 22 will remain attached to the cob and that more “milk” will be released from inside the kernels 22. Additionally, it has been found that while many of the prior art devices utilized a cutting element that was adjustable in diameter, having a stripper element with a fixed diameter provides a more rigid tool that is easier to use and, because of the relatively small variability in the diameter of cobs, works efficiently to remove the kernels 22 from ears of corn 20 of the wide range of sizes found in most markets. Without limiting the generality of the foregoing, it is also believed that the rounded or chamfered edge 18 reduces the need to adjust the diameter of the annular stripper element 12. Of course, the corn stripper 10 could be manufactured with different diameters of stripper elements 12 if it is found that ears of corn 20 run larger, or smaller, in certain areas or markets.

The preferred embodiment of the corn stripper 10 is manufactured from two pieces of stainless steel. The stripper element 12 is preferably formed from tubular stainless steel that is cut to length and preferably beveled. It may be necessary to round or chamfer the edge, if as a result of the beveling operation, if it has become sharpened. The handle 14 is preferably formed by bending stainless steel wire or rod into the desired shape and securing the ends together by weldments or the like. The handle 14 is secured to the stripper element 12, also preferably by weldments or the like. In a preferred embodiment, the handle 14 is formed of 0.25 inch diameter rod, is 8 inches long and has grasping sections 24 and 26 that are 4 inches wide. The stripper element 12 is formed of 1.5 inch, 0.065 inch tube and is 1.5 inches long. The grasping sections 24 and 26 are 1.75 inches above the edge 18.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

I claim:

1. A corn stripper, comprising:
(a) an annular stripper element of a fixed diameter;
(b) a handle secured to the stripper element and extended on opposing sides of the stripper element.

2. The corn stripper as defined in claim 1, wherein the length or height of the stripper element is between one-half and two times its diameter.

3. The corn stripper as defined on claim 2, wherein the length or height of the stripper element is between three-fourths and five-fourths times its diameter.

4. The corn stripper as defined in claim 1, further comprising a rounded bottom edge on the stripper element.

5. The corn stripper as defined in claim 1, wherein the handle is of a bow tie shape having a narrow central portion.

6. The corn stripper as defined in claim 5, wherein the handle comprises a pair of wide, hand grasped sections on opposing sides of the narrow central portion.

7. The corn stripper as defined in claim 5, wherein the stripper element is secured to the narrow central portion.

8. The corn stripper as defined in claim 1, wherein the extended side portions of the handle extend upwardly from the stripper element.

9. A corn stripper for removing kernels from an ear of corn, comprising:
(a) an annular stripping element having a fixed diameter and length or height that is between three-fourths and five-fourths the diameter;
(b) a bow tie shaped handle having opposing handle portions that extend outwardly and upwardly from a narrow, open central portion and which is secured at the narrow central portion to opposite sides of the stripper element; and
(c) an edge formed in the bottom of the stripper element that is rounded or chamfered to promote stripping of kernels.
